(19) United States
(12) Patent Application Publication
(10) Pub. No.: US 2011/0050170 A1
(43) Pub. Date: Mar. 3, 2011

(54) Electromechanical Vampire Proof Battery Charger System

(76) Inventor: Jeffrey R. Eastlack, Austin, TX (US)

(21) Appl. No.: 12/709,502

(22) Filed: Feb. 21, 2010

Related U.S. Application Data
(60) Provisional application No. 61/154,414, filed on Feb. 22, 2009.

(51) Int. Cl. H02J 7/02; H02J 7/00

(52) U.S. Cl. 320/111; 320/107

(57) ABSTRACT

A method of eliminating vampire energy loss in battery charges is provided. Vampire energy loss occurs when an electronic or mechanical machine consumes energy while not being utilized for the purpose of its existence, for example, energy loss in re-charging consumer electronic devices. By employing the use of an electromechanical switching method that creates a conductive short circuit to the charger after disconnecting the charged target device, the vampire or no load energy loss can be eliminated with or without disconnecting the charger.

This application claims the benefit of U.S. Provisional Application No. 61/154,414, filed on Feb. 22, 2009, which is incorporated herein by reference.

### FIELD OF INVENTION

The present invention relates to energy loss elimination. Particularly, the present invention relates to power efficient battery chargers and technology that eliminates vampire energy loss by using an electromechanical switching method for the power grid disconnect of the battery charger.

### BACKGROUND

Nowadays, energy conservancy has become a big issue in the overall global warming concern. How to prevent vampire energy loss presents a challenge to our industry because vampire energy loss, also called no-load/phantom loads energy loss or standby power loss, constitutes a substantial amount of our nation's energy waste.

The basic scheme of a charger with a target load is depicted in FIG. 1. As shown in FIG. 1, the charger is plugged into an AC power source 102 in the wall; through a wall receptacle it employs the use of a step-down transformer 104, signal rectification circuitry 106, and voltage regulation circuitry 108. The transformer consists of two conductively independent coils that are mutually coupled by magnetic flux when current flows in one of them. The AC current flowing in the primary coil produces a changing magnetic field within the transformer core and thereby induces an electric current in the secondary coil as described by Faraday's Law.

With a conductive path established between the AC power source 102 and the AC current domain of the primary coil of the transformer 104 magnetic coupling between the secondary coil commences to allow a stepped down AC power signal to the rectification circuitry 106 and then DC power to the regulation circuitry 108 of the DC power supply or battery charger 112.

However, this charger use comes with energy loss. The “no-load loss” or the so-called “phantom loads loss” are energy loss that occurs when an electronic or mechanical machine still consumes energy while not being used. The “no-load loss” or the “vampire energy loss”, from the transformer theory, is energy loss that occurs even when the secondary coil is left open or not attached to a load. According to academic literatures, the cause of no-load loss within transformers is attributed to eddy currents and magnetic hysteresis within the transformer core.

In addition to no-load loss or vampire loss from the transformer, DC power supplies also incur dynamic and static power loss within the rectification and regulation circuitry. Further, all of these combined losses within the DC power supply attribute to a significant portion of “vampire energy loss” which exists in many electronic product domains. Although techniques have been in place to reduce no-load loss within transformers, however, the only way to completely stop no-load loss of the DC power supply or charger is to completely disconnect it from the power grid. There are existing solutions for reducing vampire power loss but they are markedly different from the present invention.

One solution is about the USB Ecostrip. In the design of this USB connected power strip, the power bus of a standard USB compliant port of a host device is used to provide the power to the switching mechanisms of the power strip. If the USB host is turned off, the power strip then provides no power for other devices on the power strip. In another power strip design called the Smart Power Strip, one master outlet on the strip controls six other slave outlets. When the power usage of the master outlet decreases, it automatically turns off the slave outlets. The smart power strip monitors the power usage of a master device and makes the assumption that a slave device adheres to the same use case as the master device.

There are many possible cases where slave devices require power during times that a master device does not. These conditions may limit the functionality of both the USB Ecostrip and the Smart Power Strip for many peripheral devices which could result in vampire energy loss.

Alternative solution from aforementioned solution is to utilize electronic control circuits for applications that can specifically shutdown the charger from the power grid when not in use. However, this alternative requires more electronic circuitry and is relatively expensive to manufacture.

Another solution is to involve the use of solid state devices and additional circuitry in manufacturing to initiate self-disconnect when the circuitry is not in use. However, the additional circuitry and solid state devices add more costs and making the solution more expensive to produce.

Furthermore, many inventions lack an application specific shutdown mechanism, which makes the disconnection less elegant where energy loss can occur, such as a smart strip. In a smart strip operation, for example, a charger attached to a slave outlet does not charge batteries unless the master outlet on the smart strip is in use. In an application specific shutdown, to the contrary, the charger can remain on the grid and does not incur vampire loss.

In addition to have chargers remain on the grid, the cost of application specific shutdown mechanism is low. Mobile device battery chargers and commercial electronic products are extremely price sensitive. A viable solution must be able to be implemented at a low cost. Therefore, there is a need for a cost effective battery charger that eliminates the vampire energy loss without the use of costly circuitry.

### SUMMARY

Accordingly, it is an object of the present invention to provide a method of eliminating vampire power loss with low manufacturing cost.

It is also an object of the present invention to provide an electromechanical vampire proof battery charger system for controlling and disconnecting of the charger from the power grid.

It is another object of the present invention to provide a method that requires the existence of support hardware on a target device to implement a mechanical switching mechanism to disconnect charger from an electric power grid.

An actual switching mechanism is provided in the form of a conductive short circuit on the phone or other target devices to eliminate vampire energy loss. This actual switching mechanism is capable of being integrated into future target designs.

The actual switching mechanism of the present invention requires hardware support from the target devices, and can be applied to other mobile computing devices and electrical machines.

Other objects, advantages and novel features of the present invention will become more apparent from the following detailed description when taken in conjunction with the accompanying drawings.

### BRIEF DESCRIPTION OF THE DRAWINGS

FIG. 1 illustrates basic components of a typical battery charger without vampire proof capabilities;

FIG. 2 illustrates a preferred embodiment of the present invention showing an application block diagram of the integration of the electromechanical switching circuit with future charger designs and the necessary circuit signal support from future mobile devices;

FIG. 3 is a schematic diagram illustrating connection ports which map to signals shown in FIG. 1 and FIG. 2 diagrams and the design of the necessary hardware with the charger's AC signal from the charger to the target devices;

FIG. 4 is a usage flow chart that illustrates temporal operation of a preferred embodiment of the present invention;

FIG. 5 illustrates a charger hardware with four terminal connection ports of a preferred embodiment of the present invention; and

FIG. 6 illustrates an example of expansion use of a preferred embodiment of the present invention into other products and machines of various types of battery operated portable devices.

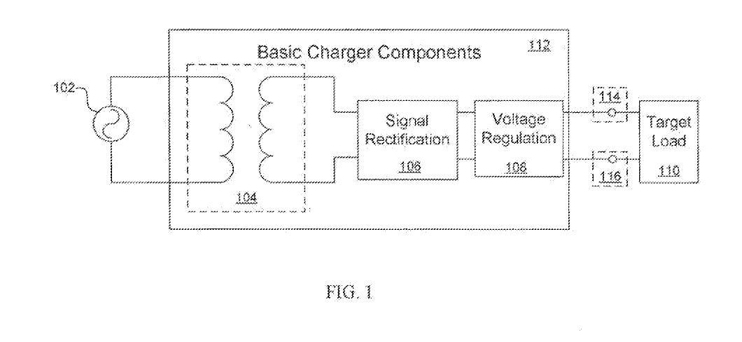

### DETAILED DESCRIPTION OF PREFERRED EMBODIMENTS

The present invention comprises a short circuit feedback loop and requires some hardware support from target devices. The present invention also requires the use of conductive wires and connector plugs to route the AC power source to the target device, then for feedback directly or indirectly to the primary coil of the charger's transformer.

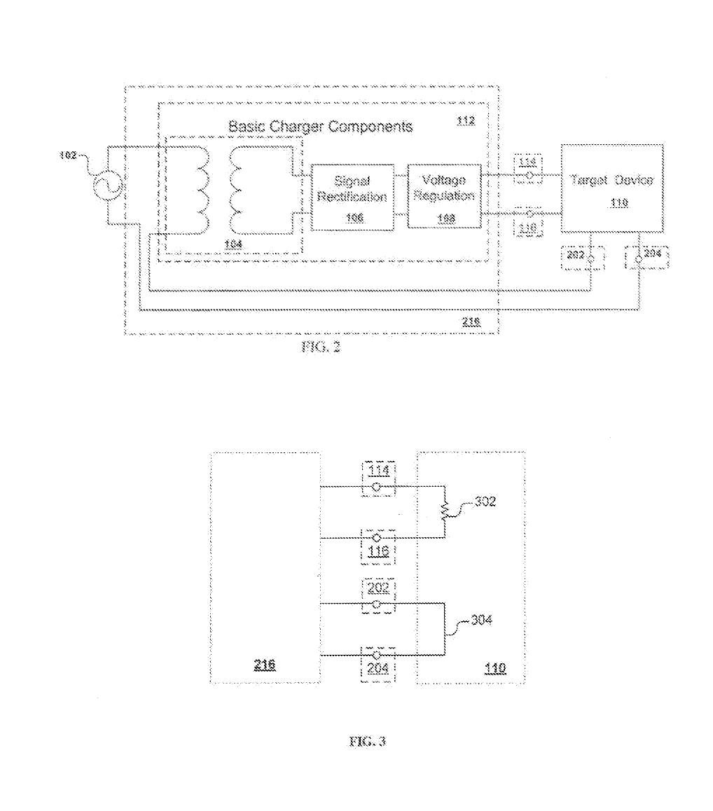

Now referring to FIG. 2, an AC power source 102, a set of charger components 216, and a target device 110 are depicted. The basic battery charger or DC power supply circuitry 112 is slightly augmented 216 to allow one port of the AC power source 102 to be routed to the target device 110 for feedback directly or indirectly to the primary coil of the step down transformer 104.

In this preferred embodiment, a switching mechanism is employed to eliminate vampire energy loss. As shown in FIG. 2, an augmented charger 216 including a charger 112 is connected with a target device 110 in series with an AC power source 102. There are two ports 202 and 204 and two ground signals 114 and 116. The charger 112 includes a step-down transformer 104, a signal rectification circuitry 106, and a voltage regulation circuitry 108.

Specifically, the AC power signal 102 going directly from the wall receptacle to the primary coil is diverted to the target device 110 via two conductive paths depicted by 202 and 204. At the target device 110, a feedback loop composed of a conductive short circuit is implemented on the target device. Whenever the target device is removed from the charger, the feedback loop with ports 114 and 116 not connected to ports 202 and 204, a short circuit is formed.

This formed short circuit will prevent vampire loss via the open circuit of signal ports 202 and 204 from the broken conductivity of circuit 304 after breaking the conductive feedback loop 304, as shown in FIG. 3. This disallows current to flow into the primary coil of the voltage transformer 104 which electrically disconnects the charger from the AC power source 102 and thus eliminates all “no-load” energy losses associated with the AC to DC power conversion process.

Now referring to FIG. 3, the actual switching mechanism is realized in the form of a conductive short circuit as shown by 304. The support hardware of the target device 110 is consisted of a conductive feedback loop 304 in connection to ports 202 and 204. The support hardware is also connected to DC power and ground signals 114 and 116. All signal ports 114, 116, 202, and 204 are in connection to the augmented charger 216.

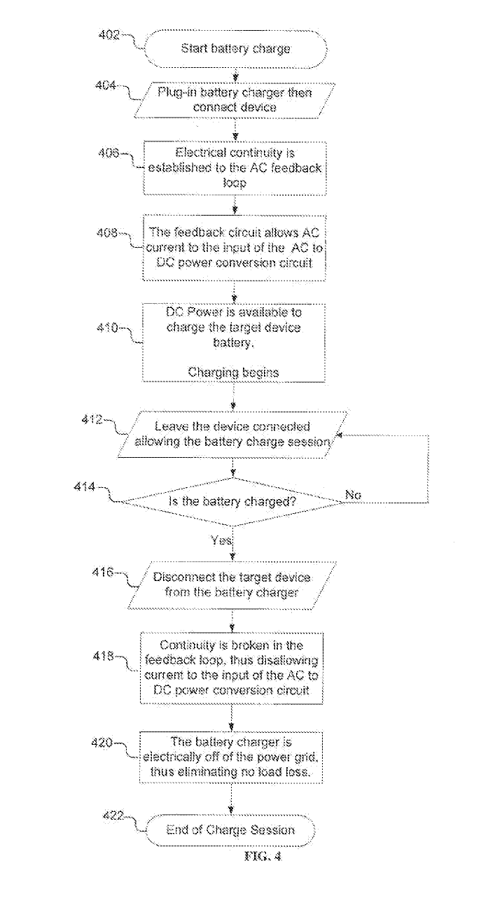

Now referring to FIG. 4, a flow chart explicitly shows the operation of an electrical device and the functions of the switching mechanism of the preferred embodiment of the present invention. To start charging the battery 402, a charger is first plugged into a wall AC power source and then connect target device 404. By connecting to the AC power resource, the electrical continuity is established to the AC feedback loop 406.

Further, the feedback circuit allowing AC current directly or indirectly to the primary coil of the transformer allows the AC to DC power conversion 408. The DC power is then available to charge the target device. The charging begins 410. The target device is now left connected to the power source and the charge session continues 412.

When the battery is fully charged, the operation moves to the next step 414. If not, the charge session will continue. After finishing up the charge session, the target device will be disconnected from the charger 416. That is, the continuity is broken in the feedback loop which disallows the current flow to the primary coil of the step down transformer 418 or to the input of the power conversion circuit, and the battery charge is electrically off of the power grid, thus eliminating no load or vampire energy loss 420. The charge session is now ended 422.

In FIG. 4, the feedback loop bridges the circuit to the primary coil of the step down transformer 104 or the power conversion input circuit allowing AC current to flow to the charger. Shown in step 404, the conductive path between ports 202 and 204 is established via physical and electrical short circuit 304 that is provided on the target device 110, also shown in FIG. 3. The process just stated is shown temporally the temporal between steps 404 to 410 that are completed nearly instantaneously to provide the appropriate DC voltage via signals 114 and 116 to target device 110 which is shown as the effective resistive load 302 in FIG. 3.

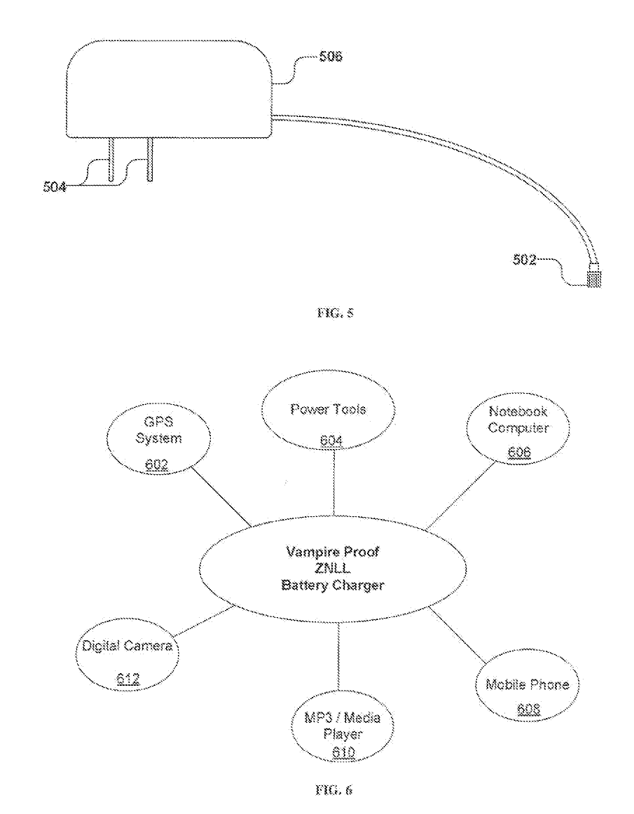

A charger enclosure 506 with two AC prongs 504 and a 4-port connection plug terminal 502 are depicted in FIG. 5. The present invention eliminates vampire energy loss in this particular application domain which includes the “no load loss” of the step down transformer 104, static and dynamic power consumption of the signal rectification 106 and regulation 108 circuitry within the device battery charger 112. The circuitry of the present invention has been designed to be integrated into future charger designs and requires hardware support from the target device.

In FIG. 5, to initiate a charge session, the charger's prongs 504 must be plugged into the wall receptacle and the target device must be connected to the 4 port charger connection terminal 502. Once the battery is charged the user can simply disconnect the 4-port charger's connector 502 composed of signals 114, 116, 202, and 204 from the target device 110 without removing the chargers AC prongs 504 from the AC power source 102 at the wall receptacle. With or without unplug the charger prongs, vampire energy loss is eliminated.

At this point the charger is physically plugged into the wall but electrically disconnected from the power grid via open circuit of signal ports 202 and 204 from the broken conductivity of circuit 304. This disallows current to flow into the primary coil of the voltage transformer 104 or the power conversion input circuit which electrically disconnects the charger from the AC power source 102 and thus eliminates all vampire or no load energy losses.

Now refer to FIG. 6, many applications and mobile devices that the electromechanical switching mechanism of the present invention can be applied to or integrated into are shown in the schematic diagram, such as GPS systems 602, power tools 604, notebook computers 606, mobile phones 608, MP3/media Player 610, and digital cameras 612. Many other applications and devices can also be utilized coupled with the electromechanical switching mechanism of the present invention.

The aforementioned preferred embodiments of the present invention were chosen and described in order to best explain the principles of the present invention and the practical applications, and best understand the present invention for various embodiments with various modifications as are suited to the particular use contemplated.

The description of the present invention has been presented for purposes of illustration and description, but is not intended to be exhaustive or limited to the present invention in the form disclosed. Modifications and variations will be apparent to those skilled in the art without departing from the scope and spirit of the invention.

What we claimed is:

1. A charger for recharging energy connected to a power source and a target load comprises:
a charger enclosure;
a plurality of prongs for connecting to a power source; and
a connection plug with four signal ports for connecting to a target load.

2. The charger for recharging energy as claimed in claim 1, wherein the charger enclosure comprises a transformer, a signal rectification circuitry, and a voltage regulation circuitry.

3. The charger for recharging energy as claimed in claim 1 further comprises a feedback loop formed at the connection plug, wherein two of the four signal ports are connected in series to the power source and the primary coil of the transformer within the charger enclosure.

4. The charger for recharging energy as claimed in claim 1 further comprises a feedback loop formed at the connection plug, wherein two of the four signal ports are connected in series to the power source and AC inputs of the chargers power conversion circuit within the charger enclosure.

5. The charger for recharging energy as claimed in claim 4, wherein the feedback loop is broken when the target load is disconnected from the connection plug.

6. The charger for recharging energy as claimed in claim 4, wherein two of the four signal ports provide DC power to the target device whereas the other two carry AC power to the charger input.

7. The charger for recharging energy as claimed in claim 1, wherein the target load can be a plurality of applications and mobile devices.

8. The charger for recharging energy as claimed in claim 7, wherein the applications is all battery operated mobile devices.

9. The charger for recharging energy as claimed in claim 7, wherein the mobile devices are power tools, notebook computers, mobile phones, digital cameras, and MP3/Media players.

10. The charger for recharging energy as claimed in claim 1, wherein the charger power conversion circuit does not consume vampire or phantom energy even when it is plugged into the power source.

11. An electromechanical switching method for eliminating vampire energy loss comprises:
enabling charging function of a charger by forming a AC power feedback loop from a target device by using a plurality of signal ports at the connection plug of a charger; and
disabling charging function of a charger by breaking the feedback loop when disconnecting a target device from the charger.

12. The electromechanical switching method for eliminating vampire energy loss as claimed in claim 11 further comprises providing a plurality of signal ports at a connection plug of a charger.

13. The electromechanical switching method for eliminating vampire energy loss as claimed in claim 11 further comprises forming a resistive load at the connection plug with two of the plurality of signal ports.

14. The electromechanical switching method for eliminating vampire energy loss as claimed in claim 13, wherein the feedback loop is coupled with the DC power signals at the connection plug to the target device.

15. The electromechanical switching method for eliminating vampire energy loss as claimed in claim 11, wherein the feedback loop is formed by connecting a plurality of signal ports at the connection plug in series with the power source and a transformer within a charger enclosure.

16. The electromechanical switching method for eliminating vampire energy loss as claimed in claim 11, wherein the feedback loop is formed by connecting a plurality of signal ports at the connection plug in series with the power source and AC inputs of the chargers power conversion circuit within the charger enclosure.

17. The electromechanical switching method for eliminating vampire energy loss as claimed in claim 11 further comprises implementing charging function on a plurality of applications and mobile devices.

18. The electromechanical switching method for eliminating vampire energy loss as claimed in claim 17, wherein the plurality of applications includes GPS systems, cell phones and laptops.

19. The electromechanical switching method for eliminating vampire energy loss as claimed in claim 17, wherein the plurality of mobile devices includes power tools, notebook computers, mobile phones, digital cameras, and MP3/Media players.

20. The electromechanical switching method for eliminating vampire energy loss as claimed in claim 11, wherein no vampire or phantom energy consumption even when a charger stays plugged into a power source when the target device is not connected.
